(19) United States
(12) Patent Application Publication
(10) Pub. No.: US 2025/0058452 A1
(43) Pub. Date: Feb. 20, 2025

(54) Handle structure of a garden tool

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 18/235,258

(22) Filed: Aug. 17, 2023

(51) Int. Cl. B25G 1/10

(52) U.S. Cl. CPC B25G 1/10; A01G 3/02; B05B 9/01

(57) ABSTRACT

A handle structure for a garden tool, and the handle structure has a handle and a padding member. An accepting slot is formed inside the handle, and there are several binding apertures on the handle, and one end of the binding aperture is a circular edge connected to a rim in the accepting slot. The circular edge has a guiding slope that gradually expands toward the other end of the rim, and a circular groove is provided on the periphery of the handle. There are several positioning columns protruding from the padding member. The positioning column is hollow and an engaging groove is adjacent to the positioning column.

### BACKGROUND of INVENTION

### Field of Invention

The present invention relates to a handle structure.

### Description of the Related Art

Typically, gardening tools such as gardening spray guns or gardening shears are all equipped with the handles, and for the convenience of holding, the surface of the handle is usually covered with a padding member, so that the padding member can be anti-slip but also provides a soft texture.

However, the above-mentioned conventional structure still has the following problems in practical application: the conventional padding member is only simply used for covering the handle but not embedded, which may cause insufficient bonding strength. Therefore, the padding member is easy to be lifted up from the edge which makes the handle obviously less durable.

Therefore, it is desirable to provide a handle structure to mitigate and/or obviate the aforementioned problems.

### SUMMARY OF THE INVENTION

An objective of present invention is to provide a handle structure of gardening tool which is capable of improving the above-mention problems.

In order to achieve the above mentioned objective, A handle structure for a garden tool, and the handle structure has a handle and a padding member. An accepting slot is formed inside the handle, and there are several binding apertures on the handle, and one end of the binding aperture is a circular edge connected to a rim in the accepting slot. The circular edge has a guiding slope that gradually expands toward the other end of the rim, and a circular groove is provided on the periphery of the handle. There are several positioning columns protruding from the padding member. The positioning column is hollow and an engaging groove is adjacent to the positioning column.

Other objects, advantages, and novel features of invention will become more apparent from the following detailed description when taken in conjunction with the accompanying drawings.

### BRIEF DESCRIPTION OF DRAWINGS

FIG. 1 is a three-dimensional composite drawing of a preferred embodiment of the present invention.

FIG. 2 is the three-dimensional exploded view of the preferred embodiment of the present invention.

FIG. 3 is a plane combination drawing of the preferred embodiment of the present invention.

FIG. 4 is a cross-sectional drawing of the preferred embodiment of the present invention.

FIG. 5 is a partial enlarged view of the cross sectional drawing of the preferred embodiment of the present invention.

FIG. 6 is another cross-sectional drawing of the preferred embodiment of the present invention.

FIG. 7 is another cross-sectional drawing of the preferred embodiment of the present invention.

### DETAILED DESCRIPTION OF THE PREFERRED EMBODIMENT

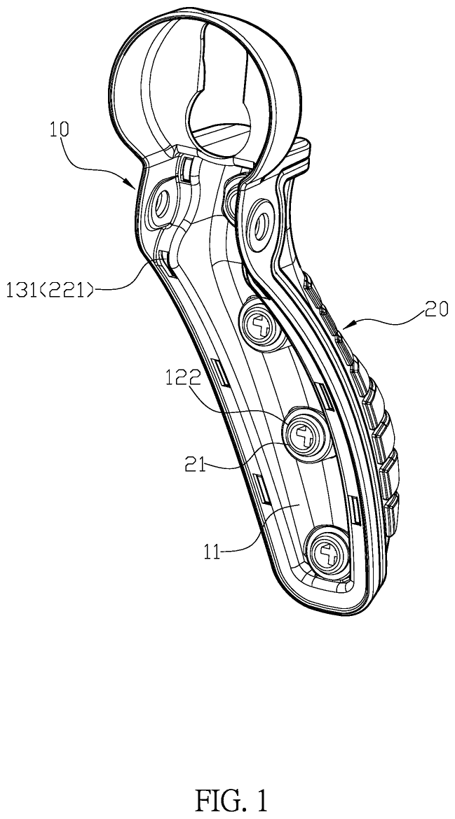

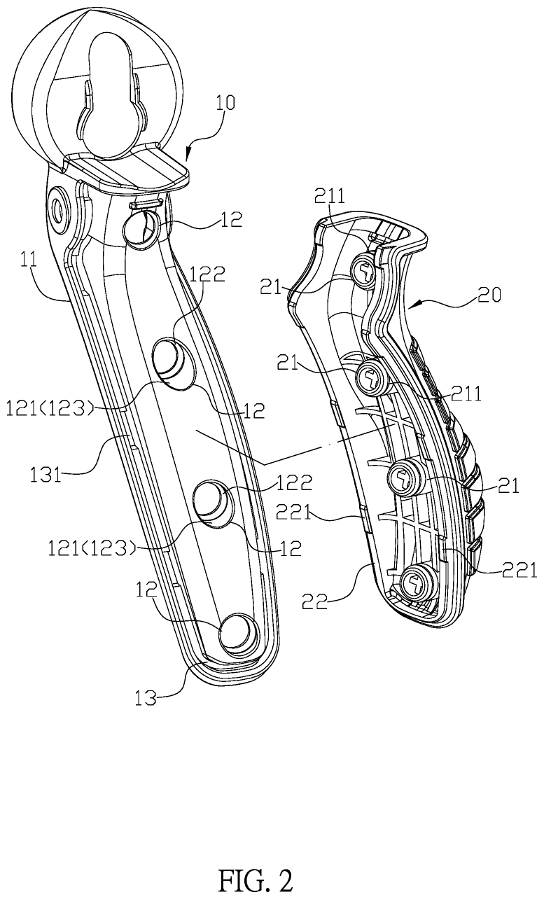

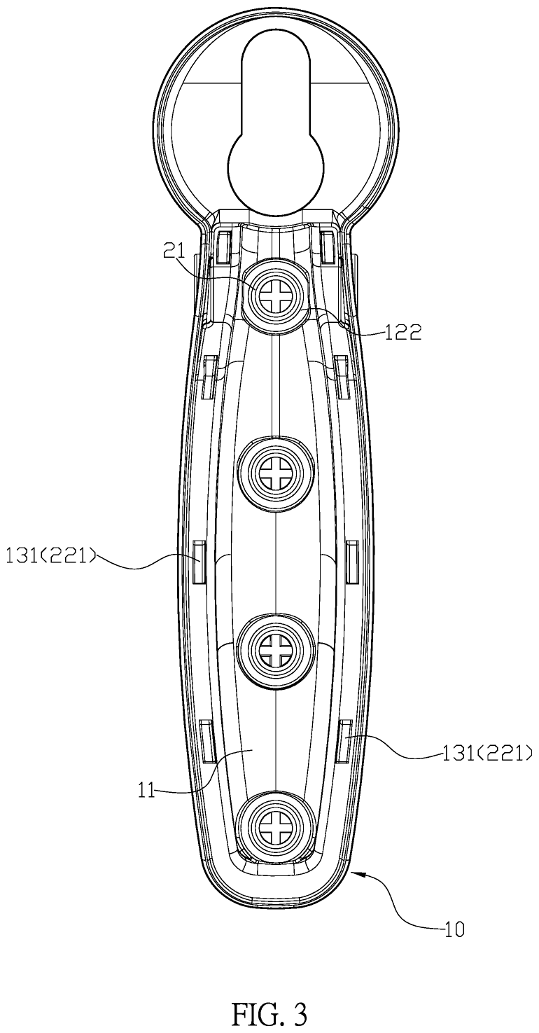

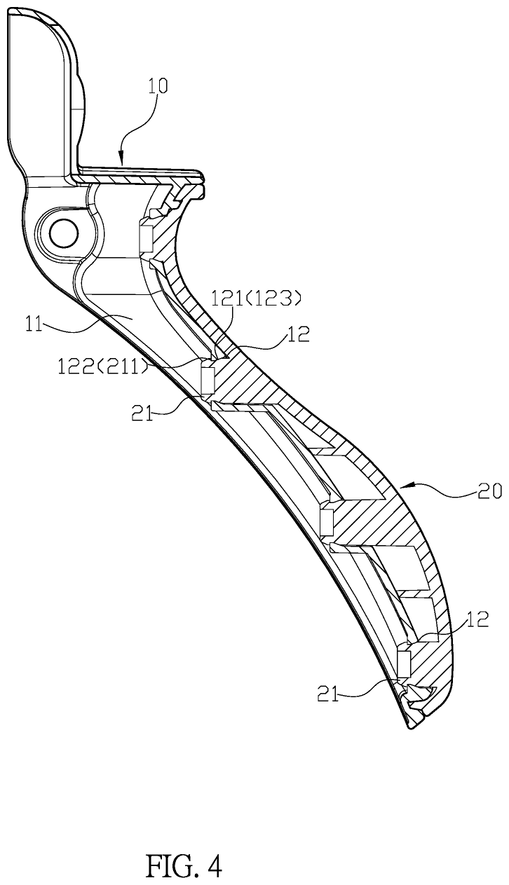

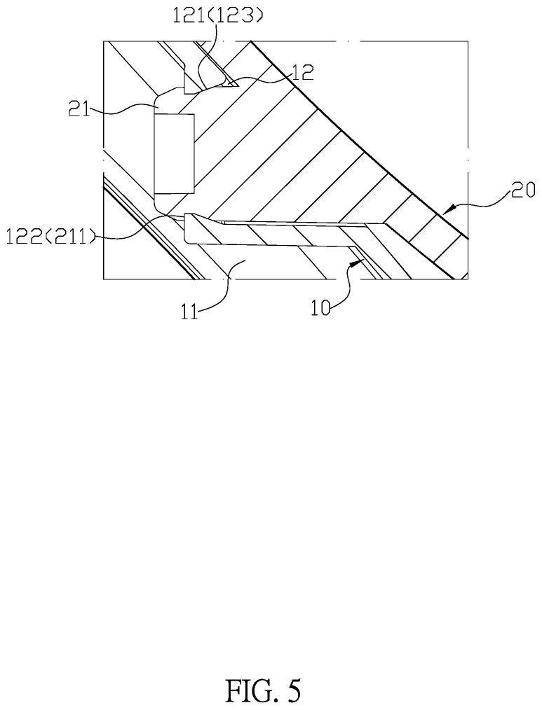

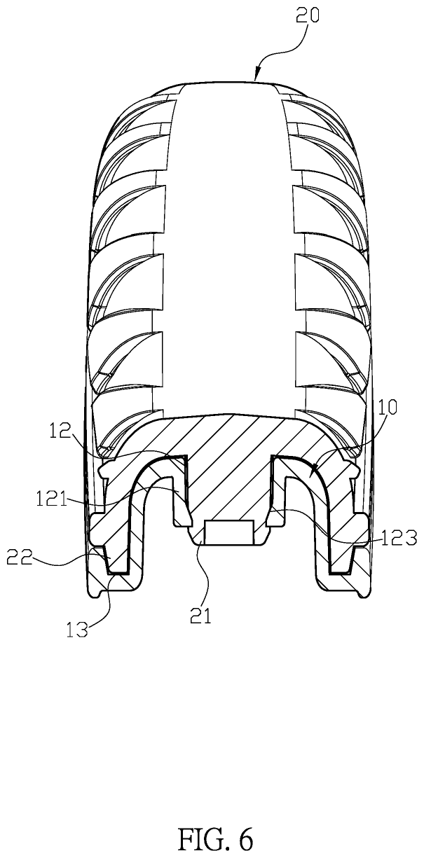

First, please refer to FIG. 1-FIG. 7. A handle structure of a garden tool comprises a handle 10 and a padding member 20. The handle 10 has a accepting slot 11 and a plurality of binding apertures, 12. One end of each binding aperture 12 has a rim 122 at a circular edge 121 in the accepting slot 12. The circular edge 121 further has a guiding slope 123 expanding towards the rim 122, and a circular groove 13 is disposed adjacent to the handle 10. The padding member 20 is configured to provide resilient texture, and the padding member 20 has a plurality of positioning columns 21 corresponding to the binding apertures 12 such that the padding member 20 is overlappable and securable onto the handle 10. Each positioning column 21 is insertable into a respective binding aperture 12 and each positioning column 21 is hollow. An engaging groove 211 is disposed adjacent to an end of each positioning column 21, with the guiding slope 123, when the positioning columns 21 are inserted in the binding apertures 12, an end of each positioning column 21 can pass the respective rim 122 and engage with the rim 122 via the engaging groove 211, and an edge 22 of the padding member 20 is embeddable in the circular groove 211.

Moreover, the handle 10 and the padding member 20 are configured for a garden tool.

Additionally, the garden tool is a gardening sprayer.

Alternatively, the garden tool is a gardening shears.

Furthermore, the handle 10 is made of metal.

Also, the padding member 20 is made of flexible material such as plastic, rubber, silicon.

Moreover, the padding member 20 has anti-slip patterns on its surface.

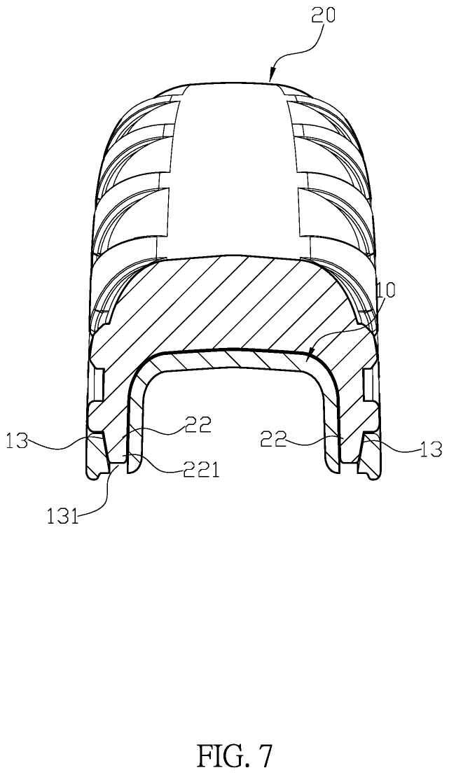

Again, the circular groove 13 of the handle 10 comprises a plurality of engaging apertures 131, and the padding member 20 comprises a plurality of engaging blocks 221 for correspondingly engaging with the engaging apertures 131, as shown in FIG. 7.

Also, wherein each engaging aperture 131 is a through hole.

Alternatively, each engaging aperture 131 is concavity.

With the structure of the above specific embodiment, the following benefits can be obtained: after the padding member 20 is overlapped, the positioning columns 21 and the binding apertures 12 engage with each other, so the bonding strength between the handle 10 and the padding member 20 can be greatly improve which makes the combination of the handle 10 and padding member 20 more durable.

Although the present invention has been explained in relation to its preferred embodiment, it is to be understood that many other possible modifications and variations can be made without departing from the spirit and scope of invention as hereinafter claimed.

What is claimed is:

1. A handle structure for a garden tool, the handle structure comprising: a handle, and a padding member, wherein:
the handle has an accepting slot and a plurality of binding apertures, one end of each binding aperture having a rim at a circular edge in the accepting slot, the circular edge further having a guiding slope expanding towards the rim, a circular groove disposed adjacent to the handle; and
the padding member is configured to provide a resilient texture, the padding member having a plurality of positioning columns corresponding to the binding apertures such that the padding member overlappable and securable onto the handle, each positioning column being insertable into a respective binding aperture and each positioning column being hollow, an engaging groove disposed adjacent to an end of each positioning column; wherein with the guiding slope, when the positioning columns are inserted in the binding apertures, an end of each positioning column can pass the respective rim and engage with the rim via the engaging groove, and an edge of the padding member is embeddable in the circular groove.

2. The handle structure for a garden tool as claimed in claim 1, wherein the garden tool is a gardening sprayer.

3. The handle structure for a garden tool as claimed in claim 1, wherein the garden tool is a gardening shears.

4. The handle structure for a garden tool as claimed in claim 1, wherein the handle is made of metal.

5. The handle structure for a garden tool as claimed in claim 1, wherein the circular groove of the handle comprises a plurality of engaging apertures, and the padding member comprises a plurality of engaging blocks for correspondingly engaging with the engaging apertures.

6. The handle structure for a garden tool as claimed in claim 5, wherein each engaging aperture is a through hole.

7. The handle structure of a garden tool as claimed in claim 5, wherein each engaging aperture is a concavity.
